(19) United States
(12) Patent Application Publication
(10) Pub. No.: US 2016/0047227 A1
(43) Pub. Date: Feb. 18, 2016

(54) Device for High-Temperature Applications

(71) Applicant: Schlumberger Technology Corporation, Sugar land, TX (US)

(72) Inventor: Shigeru Sato, Inagi-shi (JP)

(21) Appl. No.: 14/459,324

(22) Filed: Aug. 14, 2014

(51) Int. Cl. E21B 47/06; G01V 1/52

(52) U.S. Cl. CPC E21B 47/065; G01V 1/52

(57) ABSTRACT

A device for high-temperature applications is provided. The device includes a base member and at least one electrically conducting layer. The electrically conducting layer is made of polycrystalline of a first metal doped with at least one second metal different from the first metal and formed on or above the base member as electrodes for bulk acoustic vibration and/or resonance or as at least one temperature-sensitive element for sensing temperature.

### BACKGROUND

This disclosure relates generally to devices for high-temperature applications and, more particularly, to micro-electromechanical system (MEMS) devices that are suitable for applications relating to various types of downhole in oilfield or gasfield such as Measurement-While-Drilling (MWD), Logging-While-Drilling (LWD) and wireline logging applications.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In high temperature environments such as a downhole of the oilfield or gasfield, various types of devices for measurements of physical properties using bulk acoustic vibration and/or resonance. For example, sensor devices such as viscosity sensors, density sensors, accelerometers, pressure sensors, vibrating structure gyroscopes, resistance temperature devices (RTDs), etc. and clock s are used in the downhole of high temperature range up to 250° C. These devices include at least one metal layer formed on a base member as an electrode, a temperature-sensitive element, an interconnecting line, input/output pads and so on. The metal layer is made of polycrystalline of single metal element such as aluminum (Al), gold (Au) and so on.

As will become apparent from the following description and discussion, the present disclosure provides improved devices capable of operating stably and accurately in high temperature application.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In at least one aspect of the present disclosure, a device for high-temperature applications includes a base member and at least one electrically conducting layer. The electrically conducting layer is made of polycrystalline of a first metal doped with at least one second metal different from the first metal and formed on or above the base member as electrodes for bulk acoustic vibration and/or resonance or as at least one temperature-sensitive element for sensing temperature.

Advantages and novel features of the disclosures will be set forth in the description which follows or may be learned by those skilled in the art through reading the materials herein.

### BRIEF DESCRIPTION OF THE DRAWINGS

Embodiments of devices for high-temperature applications according to the disclosures herein are described with reference to the following figures. The same numbers are used throughout the figures to reference like features and components.

FIG. 1 is a schematic side view of a viscosity sensor device according to one embodiment of the disclosures herein;

FIG. 2 is a schematic side view of a density sensor device according to another embodiment of the disclosures herein;

FIG. 3 is a schematic side view of a clock according to yet another embodiment of the disclosures herein;

FIG. 4 is a schematic side view of an accelerometer according to yet another embodiment of the disclosures herein;

FIG. 5 is a schematic side view of a pressure sensor according to yet another embodiment of the disclosures herein;

FIG. 6A is a schematic side view of a vibrating structure gyroscope according to yet another embodiment of the disclosures herein and FIG. 6B is a schematic top view of the vibrating structure gyroscope;

FIG. 7 is a schematic side view of a resistance temperature device (RTD) according to yet another embodiment of the disclosures herein;

FIG. 8 is a schematic diagram of an apparatus including the device of the disclosures herein, which is used in a well passing through earth formations.

### DETAILED DESCRIPTION

Illustrative embodiments and aspects of the present disclosure are described below. In the interest of clarity, not all features of an actual implementation are described in the specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such development effort might be complex and time-consuming, but would nevertheless be a routine undertaking for those of ordinary skill in the art having benefit of the disclosure herein.

Various types of devices such as a viscosity sensor, a density sensor device, a clock, an accelerometer, a pressure sensor, a vibrating structure gyroscope and resistance temperature devices (RTDs) in the disclosures herein includes a base member and at least one electrically conducting layer. The electrically conducting layer is made of polycrystalline of a first metal such as aluminum (Al), copper (Cu), gold (Au) and silver (Ag). The first metal is doped with at least one second metal different from the first metal to improve the device capable of operating stably and accurately in high temperature applications up to 250° C. in a downhole of oilfield and gasfield.

One of advantages of the doping of second metal is to prevent or restrain phenomena of degradation and failure of the electrically conducting layer due to electromigration and/or stress-induced migration as described in documents of A. Zehe, “A Selection Rule of Solutes for Void-Resistant Crystalline Metallic Alloys Exposed to Electromigration”, Cryst. Res. Technol. 37(8) 2002, pp. 817-826 and M. Aoyagi, “Analysis of atomic diffusion mechanism of interconnect voiding failure cased by stress-induced migration”, J. Vac. Sci. Technol. B 24 (3), May/June 2006, pp. 1254-1258. These two documents are incorporated herein by reference in its entirety.

The electromigration is transport of material caused by gradual movement of metal ions in an electrically conducting layer due to a momentum transfer between conducting electrons of electric current and diffusing atoms of the first metal in the electrically conducting layer. If the transport of material is heterogeneously occurred, it may be the cause of damages such as voids, hillocks, whiskers, etc. of the electrically conducting layer and a change of mass distribution of elements in the device. The damages and change of mass distribution may affect displacement and velocity of resonance and/or vibration of sensor devices and electrically conducting characteristics of a temperature-sensitive layer of a resistance temperature device (RTD), and show a large drift and/or bias of output signals during operating with electric current drive.

In high temperature conditions of more than 150° C. in a downhole of oilfield and gasfield, the electromigration can be accelerated in proportion as a probability of:

$${AJ}^{2} exp ( - \frac{E a}{kT} ) \qquad ( 1 )$$

where A is a constant, J is an electric current density, Ea is activation energy, k is the Boltzmann constant and T is an absolute temperature. As shown in this formula (1), if temperature T increases, the electric current density J has to decrease in order to keep the same probability. This requirement is usually satisfied by change of design rule to increase width of the electrically conducting layer such as an electrode and interconnecting line. This means that state-of-the-art high integrated circuits cannot be used for high-temperature applications.

Another type of migration is stress-induced migration that is caused by mismatch of thermal expansion between the electrically conducting layer and the base member such as a substrate or passivation layers. Even if electric current does not flow in the electrically conducting layer, the stress-induced migration occurs the above-mentioned damages and change of mass distribution and may cause also permanent drift and/or bias output signals when keeping the device at high temperature such as more than 150° C.

Polycrystalline grain boundaries of the first metal in the electrically conducting layer would be main possible paths of atom diffusion by the foregoing electromigration and stress-induced migration. As described above, the device according to the disclosures herein includes the electrically conducting layer made of polycrystalline of the first metal such as Al, Cu, Au and Ag doped with the at least one second metal different from the first metal to improve the device capable of operating stably and accurately in high temperature applications up to 250° C. The doped atoms of the second metal segregate mainly at the polycrystalline grain boundaries of the first metal and prevent atom movement of the first metal driven by the electrical current flow and/or the residual stress. Therefore, the doping of the second metal into the first metal may contribute to prevent or restrain the damages and change of mass distribution due to electromigration and/or stress-induced migration.

The second metal used for the doing may be selected from the group consisting of plural metals different from the first metal and the candidates of the plural metal may be grouped so as to correspond to the kind and/or type of the first metal. Those selected second metals are only slightly soluble in the first metal such that they can segregate more at the polycrystalline grain boundaries. For that, the second metal atoms may also differ in Pauling atomic radius from the first metal atoms. For example, the at least one second metal may be selected from the group consisting of copper (Cu), zirconium (Zr) and holmium (Ho) for the first metal of aluminum (Al) and from the group consisting of tin (Sn), tantalum (Ta), palladium (Pd), vanadium (V) and zirconium (Zr) for the first metal of copper (Cu). In another example, the at least one second metal may be selected from the group consisting of cobalt (Co) and tin (Sn) for the first metal of gold (Au) and from the group consisting of cadmium (Cd), tin (Sn), and zinc (Zn) for the first metal of silver (Ag). An atomic percentage of the second metal in the first metal may be in a range of about 2 [at. %] to about 10 [at. %]. The electrically conducting layer can be deposited by sputtering, vacuum deposition, chemical vapor deposition (CVD) technique and so on. The doping amount of the second metal is measured by an analyzer such an inductively coupled plasma-mass spectroscope (ICPMS) and atomic absorption spectrophotometry (AAS).

The reduction of electromigration and stress-induced migration contributes to high stability and accuracy of output signals from the devices such as a viscosity sensor even if the devices are operated and/or stored in high temperature environment up to 250° C. in a downhole of oilfield and gasfield.

The device according to the disclosures herein may be a micro-electromechanical system (MEMS) device. The MEMS devices are designed and fabricated based on MEMS technology and has advantages of low cost, small size, lightweight, fast response and so on. Some of the conventional MEMS devices such as MEMS sensors use mechanical motions of devices elements, and the motions are induced by mechanical, electric or magnetic forces. The MEMS devices are designed for consumer use and used at relatively low temperature such as below 80° C. or 125° C. However, if the MEMS devices are needed for use in a downhole of oilfield and gasfield, ambient temperatures can be more than 150° C. or 200° C., which are not temperature that the original design of the conventional MEMS devices specified. Especially, some of the MEMS devices are highly sensitive to environmental conditions and easily influenced by mechanical properties of the device elements changed due to the environmental conditions such as ambient temperature. Accordingly, there are also advantages of the doping of the foregoing second metal to prevent or restrain phenomena of degradation and failure of the electrically conducting layer of the MEMS devices due to electromigration and/or stress-induced migration.

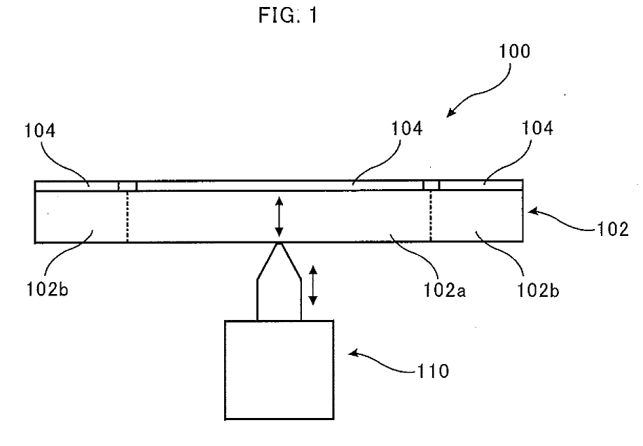

Referring now to FIG. 1, a viscosity sensor device 100 according to one embodiment of the disclosures herein is used for measurements of viscosity of liquid (fluid) or gas and comprises a base member 102 and an electrically conducting layer 104, which is fabricated by MEMS technology. The base member 102 has a central vibrating part 102a and a non-vibrating part 102b formed to surround the central vibrating part 102a, as described in Y. Yamamoto, et al., “MEMS VISCOSITY SENSOR USING DUAL SPIRAL SHAPED VIBRATING STRUCTURE”, Proc. 16th International Conference on Miniaturized Systems for Chemistry and Life Sciences, Oct. 28-Nov. 1, 2012, Okinawa, Japan, pp. 638-640 which is hereinafter called “Document 1” and incorporated herein by reference in its entirety.

The base member 102 may be made of a Si wafer with or without a surface passivation layer of Si₃N₄ etc. and the central vibrating part 102a may be fabricated to be dual spiral structure as described in Document 1. The electrically conducting layer 104 is made of polycrystalline of Au as the first metal doped with at least one of Co and Sn as the second metal at an atomic percentage in the range of about 2 [at. %] to about 10 [at. %]. The first metal may be Al and the second metal may be at least one of Cu, Zr and Ho, or the first metal may be Cu and the second metal may be at least one of Sn, Ta, Pd, V and Zr. In another example, the first metal may be Ag and the second metal may be at least one of Cd, Sn and Zn.

The electrically conducting layer 104 may include electrodes, pads and interconnecting lines. The electrodes are used for elements of a strain gauge such as a Wheatstone bridge to detect surface displacements of the central vibrating part 102a. The viscosity sensor device 100 is disposed in liquid or gas and the central vibrating part 102 is periodically pushed for vibration by a driving unit 110 such as piezoelectric element. The viscosity of the liquid or gas can be calculated based on frequency response curve of the output signals from the viscosity sensor device 100 and a predetermined formula.

In the embodiment of FIG. 1, the viscosity sensor device 100 including a doped metal layer as the electrically conducting layer 104 has an advantage to prevent or restrain the damages and change of mass distribution due to electromigration and/or stress-induced migration, and improve the viscosity sensor device 100 so as to operate and measure viscosity of liquid stably and accurately in high temperature applications up to 250° C. such as applications in a downhole of oilfield and gasfield.

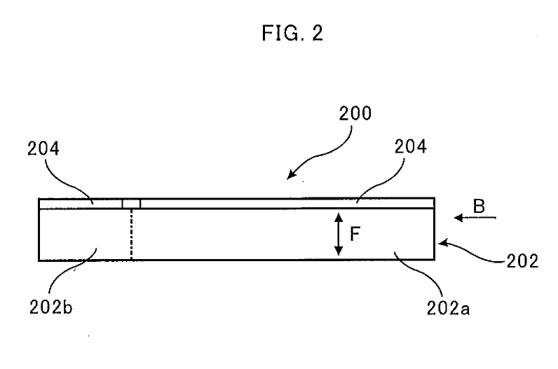

FIG. 2 is a schematic side view of a density sensor device 200 according to another embodiment of the disclosures herein. The density sensor device 200 is used for measurements of density of liquid (fluid) or gas and comprises a base member 202 and an electrically conducting layer 204, which is fabricated by MEMS technology. The base member 202 has a single-clamped microcantilever structure including a vibrating part 202a and a non-vibrating part 202b as described in G. Zhang, et al., “MEMS fluid density sensor based on oscillating piezoresistive microcantilever”, Proc. 2013 IEEE International Symposium on Assembly and Manufacturing (ISAM), Jul. 30, 2013-Aug. 2, 2013, pp. 167-169 which is hereinafter called “Document 2” and incorporated herein by reference in its entirety.

The base member 202 may be made of a Si wafer with or without a surface passivation layer of SiO₂ etc. as described in Document 2. The electrically conducting layer 204 is made of polycrystalline of Au as the first metal doped with at least one of Co and Sn as the second metal at an atomic percentage in the range of about 2 [at. %] to about 10 [at. %]. The first metal may be Al and the second metal may be at least one of Cu, Zr and Ho, or the first metal may be Cu and the second metal may be at least one of Sn, Ta, Pd, V and Zr. In another example, the first metal may be Ag and the second metal may be at least one of Cd, Sn and Zn.

The electrically conducting layer 204 may include electrodes, pads, coil and interconnecting lines. The electrodes are used for elements of a strain gauge such as a Wheatstone bridge to detect surface displacements of the vibrating part 202a. The density sensor device 200 is disposed in liquid or gas and the vibrating part 202 is driven for vibration by an alternating Lorentz force F that is generated with an external magnetic field B extending parallel to the length of the base member 202 (microcantilever) and AC voltage supplied to the coil of the electrically conducting layer 204 fabricated on the vibrating part 202. The density of the liquid or gas can be calculated based on frequency response curve of the output signals from the density sensor device 200 and a predetermined formula.

In the embodiment of FIG. 2, the density sensor device 200 including a doped metal layer as the electrically conducting layer 204 has an advantage to prevent or restrain the damages and change of mass distribution due to electromigration and/or stress-induced migration, and improve the density sensor device 200 so as to operate and measure density of liquid (fluid) stably and accurately in high temperature applications up to 250° C. such as applications in a downhole of oilfield and gasfield.

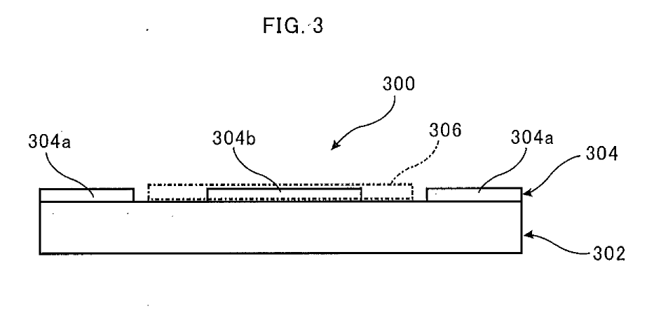

FIG. 3 is a schematic side view of a clock 300 according to yet another embodiment of the disclosures herein. The clock 300 includes a bulk acoustic resonator formed with an electrically conducting layer 304 on a substrate 302 as the base member and a movable member 306, which is fabricated by MEMS technology. The movable member 306 has one of shapes like beam, comb, web, disc, etc. surrounded by at least one driving electrode 304a and at least one sensing electrode 304b with appropriate gaps. In one example of the disclosures herein, the movable member 306 may be configured with two parallel beams coupled using two coupling block on both ends as described in B. Kim, et al., “Si—SiO₂ Composite MEMS Resonators in CMOS Compatible Wafer-scale Thin-Film Encapsulation”, Proc. 2007 IEEE International Frequency Control Symposium joint with the 21st European Frequency and Time Forum, pp. 1214-1219 which is hereinafter called “Document 3” and incorporated herein by reference in its entirety. In another example of the disclosures herein, the movable member 306 may be configured with 4-beam structure as described in C. S. Lam, “A review of the recent development of MEMS and crystal oscillators and their impacts on the frequency control products industry”, Proc. 2008 IEEE Ultrasonics Symposium, pp. 694-704 which is hereinafter called “Document 4” and incorporated herein by reference in its entirety.

The base member 302 may be made of a Si or SOI (silicon on insulator) wafer as described in Document 3 and 4. The electrically conducting layer 304 is made of polycrystalline of Al as the first metal doped with at least one of Cu, Zr and Ho as the second metal at an atomic percentage in the range of about 2 [at. %] to about 10 [at. %]. The first metal may be Au and the second metal may be at least one of Co and Sn, or the first metal may be Cu and the second metal may be at least one of Sn, Ta, Pd, V and Zr. In another example, the first metal may be Ag and the second metal may be at least one of Cd, Sn and Zn.

The electrically conducting layer 304 may include not only the driving electrodes 304a and the sensing electrode 304b but also pads and interconnecting lines. The driving electrodes 304a are connected to a driver circuit for vibrating the movable member 306 by applying an AC voltage and the sensing electrode 304b is connected to an oscillation circuit for sensing a resonance of the movable member 306 at a resonance frequency. Output signals from the oscillation circuit can be used as clock signals for various circuits of other devices.

In the embodiment of FIG. 3, the clock 300 including a doped metal layer as the electrically conducting layer 304 has an advantage to prevent or restrain the damages and change of mass distribution due to electromigration and/or stress-induced migration, and improve the clock 300 so as to operate and output clock signals stably and accurately in high temperature applications up to 250° C. such as applications in a downhole of oilfield and gasfield.

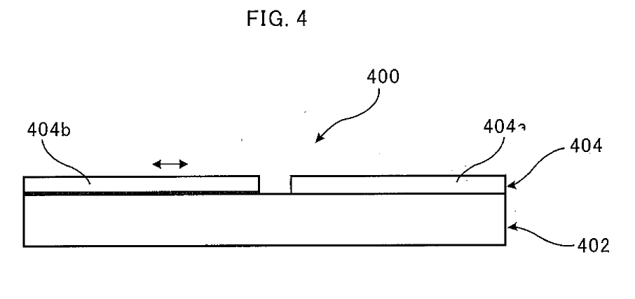

FIG. 4 is a schematic side view of an accelerometer 400 according to yet another embodiment of the disclosures herein. The accelerometer 400 is used for measurements of acceleration or gravity and includes a substrate 402 as the base member and an electrically conducting layer 404 on the substrate 402, which is fabricated by MEMS technology. The electrically conducting layer 404 includes at least one set of a fixed electrode 404a anchored on the substrate 402 and a movable electrode 404b supported on the substrate 402 via an elastic member like a spring. The fixed electrode 404a and the movable electrode 404b are opposed to each other with an appropriate gap and the movable electrode 404b can relatively vibrate against the fixed electrode 404a. In one example of the disclosures herein, the fixed electrode 404a and the movable electrode 404b may be configured with opposing surface portions having a shape like comb teeth as described in U.S. Patent Application Publication No. 2010/0222998. The U.S. Patent Application Publication No. 2010/0222998 is incorporated herein by reference in its entirety.

The substrate 402 may be made of a Si wafer with or without a surface passivation layer of SiO₂ etc. The electrically conducting layer 404 is made of polycrystalline of Al as the first metal doped with at least one of Cu, Zr and Ho as the second metal at an atomic percentage in the range of about 2 [at. %] to about 10 [at. %]. The first metal may be Au and the second metal may be at least one of Co and Sn, or the first metal may be Cu and the second metal may be at least one of Sn, Ta, Pd, V and Zr. In another example, the first metal may be Ag and the second metal may be at least one of Cd, Sn and Zn.

The electrically conducting layer 404 may include not only the fixed electrode 404a and the movable electrode 404b but also pads and interconnecting lines. The fixed electrode 404a and the movable electrode 404b are connected to a detection circuit for sensing a change of electric capacity between the fixed electrode 404a and the movable electrode 404b. Using output signals from the detection circuit can be used to calculate values and direction of acceleration or gravity.

In the embodiment of FIG. 4, the accelerometer 400 including a doped metal layer as the electrically conducting layer 404 has an advantage to prevent or restrain the damages and change of mass distribution due to electromigration and/or stress-induced migration, and improve the accelerometer 400 so as to operate and measure acceleration or gravity stably and accurately in high temperature applications up to 250° C. such as applications in a downhole of oilfield and gasfield.

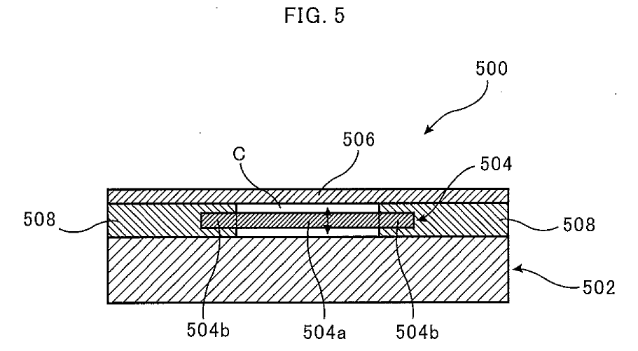

FIG. 5 is a schematic side view of a pressure sensor 500 according to yet another embodiment of the disclosures herein. The pressure sensor 500 is used for measurements of pressure of liquid or gas and includes a substrate 502 as the base member and a first electrode 504 and a second electrode 506 as electrically conducting layers located above the substrate 502, which is fabricated by MEMS technology, as described in U.S. Pat. No. 8,516,905. The U.S. Pat. No. 8,516,905 is incorporated herein by reference in its entirety. The first electrode 504 includes a vibrating portion 504a located in a cavity C and two anchor portions 504b anchored to barrier layers 508. The cavity C at pressure P to be measured is formed with internal surfaces of the substrate 502, the barrier layers 508 and the second electrode 506.

The substrate 502 may be made of a Si wafer with or without a surface passivation layer of SiO₂ etc. The first electrode 504 and the second electrode 506 are made of polycrystalline of Al as the first metal doped with at least one of Cu, Zr and Ho as the second metal at an atomic percentage in the range of about 2 [at. %] to about 10 [at. %]. The first metal may be Au and the second metal may be at least one of Co and Sn, or the first metal may be Cu and the second metal may be at least one of Sn, Ta, Pd, V and Zr. In another example, the first metal may be Ag and the second metal may be at least one of Cd, Sn and Zn.

The electrically conducting layers may include not only the first electrode 504 and the second electrode 506 but also pads and interconnecting lines. The second electrode 506 is connected to a driver circuit for vibrating the vibrating portion 504a of the first electrode 504 by applying an AC voltage and the first electrode 504 is connected to an oscillation circuit for sensing a resonance of the vibrating portion 504a at a resonance frequency. The pressure P in the cavity C can be calculated based on resonance frequency response of output signals from the oscillation circuit.

In the embodiment of FIG. 5, the pressure sensor 500 including a doped metal layer as the electrically conducting layers (the first electrode 504 and the second electrode 506) has an advantage to prevent or restrain the damages and change of mass distribution due to electromigration and/or stress-induced migration, and improve the pressure sensor 500 so as to operate and measure pressure of liquid or gas stably and accurately in high temperature applications up to 250° C. such as applications in a downhole of oilfield and gasfield.

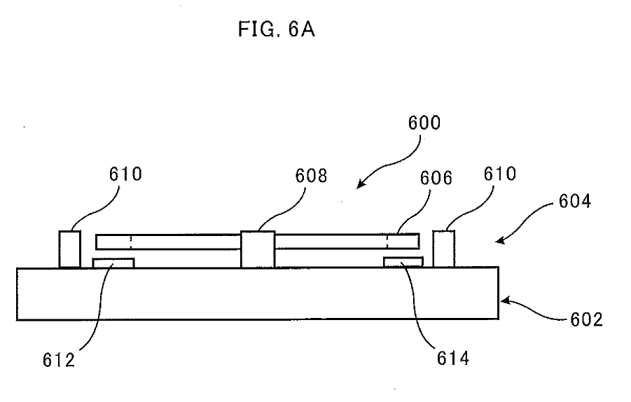

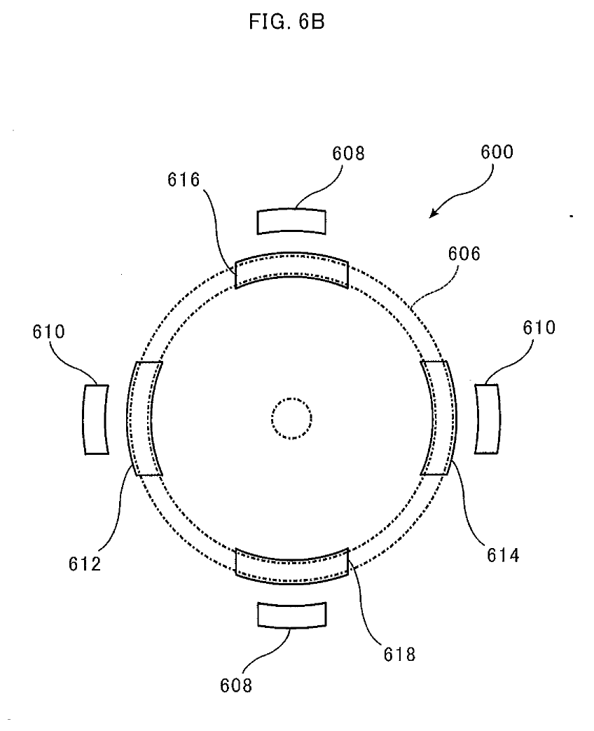

FIG. 6A is a schematic side view of a vibrating structure gyroscope 600 according to yet another embodiment of the disclosures herein and FIG. 6B is a schematic top view of the vibrating structure gyroscope 600. The gyroscope 600 is used for measurements of angular rate or angular velocity on at least two axes in a strapdown system and comprises a substrate 602 as the base member and the electrically conducting layers 604 located on or above the substrate 602, which is fabricated by MEMS technology.

The electrically conducting layers 604 includes a central movable member 606, two electrostatic carrier mode drive elements 608, two electrostatic carrier mode pick-off elements 610, an x axis electrostatic rocking mode drive element 612, an x axis electrostatic rocking mode pick-off element 614, a y axis electrostatic rocking mode drive element 616 and a y axis electrostatic rocking mode pick-off element 618. The movable member 606 may be supported with a central boss on the substrate 602 and have a shape like a circular rim (ring) shown in FIG. 6B or a rectangular rim, as described in U.S. Pat. No. 3,924,475 and U.S. Pat. No. 5,915,276. The U.S. Pat. No. 3,924,475 and the U.S. Pat. No. 5,915,276 are incorporated herein by reference in their entirety.

The carrier mode elements 608 and 610 are arranged with the drive elements 608 at 0° and 180° and the pick-off elements 610 at 90° and 270° respectively with respect to the central movable member 606. The carrier mode drive elements 608 are used to set the movable member 606 into oscillation. The carrier mode pick-off elements 610 which are located at the carrier mode anti-nodal points, sense the radial motion of the movable member 606.

The rocking mode elements 612, 614, 616 and 618 are located adjacent the movable member 606 in superimposed relationship therewith at a perpendicular spacing therefrom with the y axis drive element 616, the x axis pick-off element 614, the y axis pick-off element 618 and the x axis drive element 612 being arranged at 0°, 90°, 180° and 270° respectively around the movable member 606. The rocking motion of the x axis rate response mode is detected at the pick-off element 614 located on the surface of the support substrate under the movable member 606. This motion is nulled using the x axis drive element 612 similarly located under the opposite side of the movable member 606. The y axis rate response motion is similarly detected by pick-off element 618 and nulled by drive element 616.

The substrate 602 may be made of a Si wafer with or without a surface passivation layer of SiO₂ etc. The electrically conducting layers 604 are made of polycrystalline of Al as the first metal doped with at least one of Cu, Zr and Ho as the second metal at an atomic percentage in the range of about 2 [at. %] to about 10 [at. %]. The first metal may be Au and the second metal may be at least one of Co and Sn, or the first metal may be Cu and the second metal may be at least one of Sn, Ta, Pd, V and Zr. In another example, the first metal may be Ag and the second metal may be at least one of Cd, Sn and Zn.

The electrically conducting layers 604 may include not only the movable member 606, the carrier mode elements 608, 610 and the rocking mode elements 612, 614, 616, 618 but also pads and interconnecting lines.

In the embodiment of FIGS. 6A and 6B, the vibrating structure gyroscope 600 including a doped metal layer as the electrically conducting layers 604 has an advantage to prevent or restrain the damages and change of mass distribution due to electromigration and/or stress-induced migration, and improve the vibrating structure gyroscope 600 so as to operate and measure angular rate or angular velocity stably and accurately in high temperature applications up to 250° C. such as applications in a downhole of oilfield and gasfield.

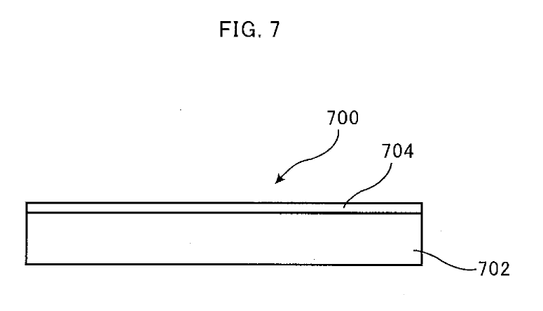

FIG. 7 is a schematic side view of a resistance temperature device (RTD) 700 according to yet another embodiment of the disclosures herein. The RTD 700 is used for temperature measurements and comprises a base member 702 and a temperature-sensitive layer 704, which is fabricated by MEMS technology. The temperature-sensitive layer 704 exhibits a linear change in resistance r with a change in temperature T. By using a formula such as r=r0 (1+a (T−T0), the temperature can be calculated when the change in resistance is measured.

The base member 702 may be made of a Si wafer with or without a surface passivation layer of Si₃N₄ etc. The temperature-sensitive layer 704 is made of polycrystalline of Cu as the first metal doped with at least one of Sn, Ta, Pd, V and Zr as the second metal at an atomic percentage in the range of about 2 [at. %] to about 10 [at. %]. The first metal may be Al and the second metal may be at least one of Cu, Zr and Ho, or the first metal may be Au and the second metal may be at least one of Co and Sn. In another example, the first metal may be Ag and the second metal may be at least one of Cd, Sn and Zn.

In the embodiment of FIG. 7, the RTD 700 including a doped metal layer as the temperature-sensitive layer 704 has an advantage to prevent or restrain the damages and change of mass distribution due to electromigration and/or stress-induced migration, and improve the RTD 700 so as to operate and measure temperatures in high temperature applications up to 250° C. such as applications in a downhole of oilfield and gasfield.

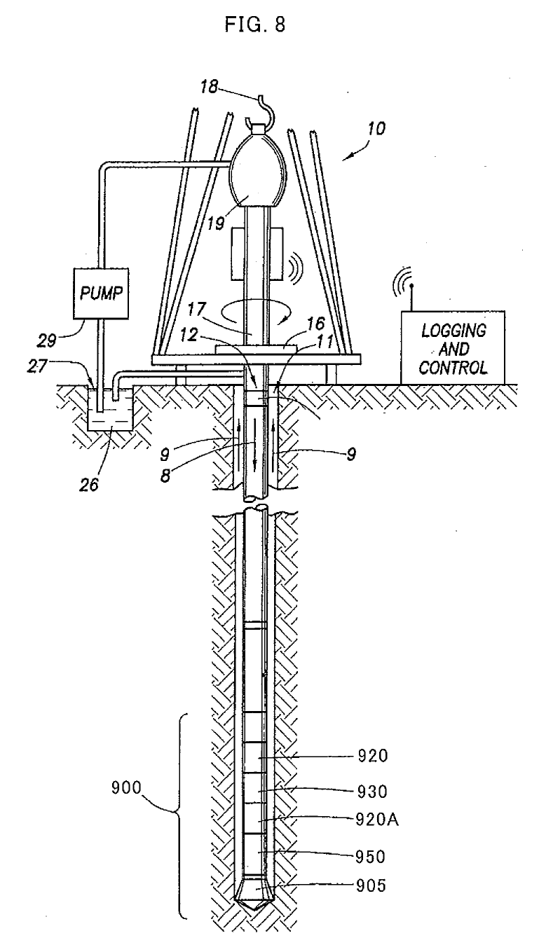

FIG. 8 illustrates a wellsite system in which at least one of the devices of the disclosures herein can be employed. The wellsite can be onshore or offshore. In this exemplary system, a borehole 11 is formed in subsurface formations by rotary drilling in a manner that is well known. Embodiments of the disclosures can also use directional drilling, as will be described hereinafter.

A drill string 12 is suspended within the borehole 11 and has a bottom hole assembly 900 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook. As is well known, a top drive system could alternatively be used.

In the example of this embodiment, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 905, and then circulates upwardly through the annulus region between the outside of the drill string and the wall of the borehole, as indicated by the directional arrows 9. In this well known manner, the drilling fluid lubricates the drill bit 905 and carries formation cuttings up to the surface as it is returned to the pit 27 for recirculation. The bottom hole assembly 900 of the illustrated embodiment a logging-while-drilling (LWD) module 920, a measuring-while-drilling (MWD) module 930, a roto-steerable system and motor, and drill bit 905.

The LWD module 920 is housed in a special type of drill collar, as is known in the art, and can contain one or a plurality of known types of logging tools. It will also be understood that more than one LWD and/or MWD module can be employed, e.g. as represented at 920A. (References, throughout, to a module at the position of 920 can alternatively mean a module at the position of 920A as well.) The LWD module includes capabilities for measuring, processing, and storing information, as well as for communicating with the surface equipment. In the present embodiment, the LWD module includes a pressure measuring device.

The MWD module 930 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

A particularly advantageous use of the system hereof is in conjunction with controlled steering or “directional drilling.” In this embodiment, a roto-steerable subsystem 950 is provided. Directional drilling is the intentional deviation of the wellbore from the path it would naturally take. In other words, directional drilling is the steering of the drill string so that it travels in a desired direction. Directional drilling is, for example, advantageous in offshore drilling because it enables many wells to be drilled from a single platform. Directional drilling also enables horizontal drilling through a reservoir. Horizontal drilling enables a longer length of the wellbore to traverse the reservoir, which increases the production rate from the well. A directional drilling system may also be used in vertical drilling operation as well. Often the drill bit will veer off of a planned drilling trajectory because of the unpredictable nature of the formations being penetrated or the varying forces that the drill bit experiences. When such a deviation occurs, a directional drilling system may be used to put the drill bit back on course. A known method of directional drilling includes the use of a rotary steerable system (“RSS”). In an RSS, the drill string is rotated from the surface, and downhole devices cause the drill bit to drill in the desired direction. Rotating the drill string greatly reduces the occurrences of the drill string getting hung up or stuck during drilling. Rotary steerable drilling systems for drilling deviated boreholes into the earth may be generally classified as either “point-the-bit” systems or “push-the-bit” systems. In the point-the-bit system, the axis of rotation of the drill bit is deviated from the local axis of the bottom hole assembly in the general direction of the new hole. The hole is propagated in accordance with the customary three-point geometry defined by upper and lower stabilizer touch points and the drill bit. The angle of deviation of the drill bit axis coupled with a finite distance between the drill bit and lower stabilizer results in the non-collinear condition required for a curve to be generated. There are many ways in which this may be achieved including a fixed bend at a point in the bottom hole assembly close to the lower stabilizer or a flexure of the drill bit drive shaft distributed between the upper and lower stabilizer. In its idealized form, the drill bit is not required to cut sideways because the bit axis is continually rotated in the direction of the curved hole. Examples of point-the-bit type rotary steerable systems, and how they operate are described in U.S. Patent Application Publication Nos. 2002/0011359; 2001/0052428 and U.S. Pat. Nos. 6,394,193; 6,364,034; 6,244,361; 6,158,529; 6,092,610; and 5,113,953 all herein incorporated by reference. In the push-the-bit rotary steerable system there is usually no specially identified mechanism to deviate the bit axis from the local bottom hole assembly axis; instead, the requisite non-collinear condition is achieved by causing either or both of the upper or lower stabilizers to apply an eccentric force or displacement in a direction that is preferentially orientated with respect to the direction of hole propagation. Again, there are many ways in which this may be achieved, including non-rotating (with respect to the hole) eccentric stabilizers (displacement based approaches) and eccentric actuators that apply force to the drill bit in the desired steering direction. Again, steering is achieved by creating non co-linearity between the drill bit and at least two other touch points. In its idealized form the drill bit is required to cut side ways in order to generate a curved hole. Examples of push-the-bit type rotary steerable systems, and how they operate are described in U.S. Pat. Nos. 5,265,682; 5,553,678; 5,803,185; 6,089,332; 5,695,015; 5,685,379; 5,706,905; 5,553,679; 5,673,763; 5,520,255; 5,603,385; 5,582,259; 5,778,992; 5,971,085 all herein incorporated by reference.

The preceding description has been presented only to illustrate and describe certain embodiments. It is not intended to be exhaustive or to limit the disclosures to any precise form disclosed. Many modifications and variations are possible in light of the above teaching.

The embodiments and aspects were chosen and described in order to best explain principles of the disclosures and its practical applications. The preceding description is intended to enable others skilled in the art to best utilize the principles in various embodiments and aspects and with various modifications as are suited to the particular use contemplated. It is intended that the scope of the disclosures be defined by the following claims.

What is claimed is:

1. A device for high-temperature applications comprising:
a base member; and
at least one electrically conducting layer that is made of polycrystalline of a first metal doped with at least one second metal different from the first metal and formed on or above the base member as electrodes for bulk acoustic vibration and/or resonance or as at least one temperature-sensitive element for sensing temperature.

2. The device according to claim 1, wherein the electrically conducting layer includes at least one interconnecting line for the electrodes or the temperature-sensitive element.

3. The device according to claim 1, wherein the device is a micro-electromechanical system (MEMS) device.

4. The device according to claim 1, wherein the device is a viscosity sensor including at least one strain gauge formed with the electrically conducting layer for sensing displacements of surface of the base member.

5. The device according to claim 1, wherein the device is a density sensor including at least one strain gauge formed with the electrically conducting layer for sensing displacements of surface of the base member

6. The device according to claim 1, wherein the device is a clock including at least one bulk acoustic resonator with the electrically conducting layer.

7. The device according to claim 1, wherein the device is an accelerometer including at least one bulk acoustic resonator with the electrically conducting layer.

8. The device according to claim 1, wherein the device is a pressure sensor device including at least one bulk acoustic resonator with the electrically conducting layer.

9. The device according to claim 1, wherein the device is a vibrating structure gyroscope including at least one bulk acoustic resonator with the electrically conducting layer.

10. The device according to claim 1, wherein the device is a resistance temperature device (RTD) including the temperature-sensitive layer on the base member.

11. The device according to claim 1, wherein the first metal is aluminum (Al) and the at least one second metal is selected from the group consisting of copper (Cu), zirconium (Zr) and holmium (Ho).

12. The device according to claim 1, wherein the first metal is Copper (Cu) and the at least one second metal is selected from the group consisting of tin (Sn), tantalum (Ta), Palladium (Pd), vanadium (V) and zirconium (Zr).

13. The device according to claim 1, wherein the first metal is gold (Au) and the at least one second metal is selected from the group consisting of cobalt (Co) and tin (Sn).

14. The device according to claim 1, wherein the first metal is silver (Ag) and the at least one second metal is selected from the group consisting of cadmium (Cd), tin (Sn), and zinc (Zn).

15. The device according to claim 1, wherein an atomic percentage of the second metal in the first metal is in a range of about 2 [at. %] to about 10 [at. %].

16. The device according to claim 1, wherein the device includes at least one of a drive circuit and an output circuit connected to the electrically conducting layer.

17. The device according to claim 1, wherein the device is used in a downhole of oilfield or gasfield.
